(19) United States
(12) Patent Application Publication
(10) Pub. No.: US 2009/0002283 A1
(43) Pub. Date: Jan. 1, 2009

(54) Organic electroluminescent device

(75) Inventors: Hongki Park, Daegu (KR); Seungho Kwon, Kyungbuk (KR)

Correspondence Address: MORGAN LEWIS & BOCKIUS LLP, 1111 PENNSYLVANIA AVENUE NW, WASHINGTON, DC, 20004, US

(73) Assignee: LG Display Co., Ltd.

(21) Appl. No.: 12/213,951

(22) Filed: Jun. 26, 2008

(30) Foreign Application Priority Data
Jun. 27, 2007 (KR) 10-2007-0063637

(51) Int. Cl. G09G 3/30

(52) U.S. Cl. 345/76

(57) ABSTRACT

An organic electroluminescent device comprises: a substrate; a display unit located on the substrate and including a plurality of subpixels; a sealing region located at the outer periphery of the display unit and defined to form a sealing member; and a plurality of wiring lines connected to the display unit and disposed on the lateral side of the display unit, more than a part of the plurality of wiring lines located in a sealing member forming region, among the plurality of wiring lines, has a narrow line width which is 10 to 50% of that of the wiring lines located in other regions.

This application claims the benefit of Korean Patent Application No. 10-2007-063637 filed ON Jun. 27, 2007, which is hereby incorporated by reference.

### BACKGROUND

1. Field of the Invention

This document relates to an organic electroluminescent device.

2. Related Art

An organic electroluminescent device used for an organic electroluminescence display is a self-light emitting device which has a light emitting layer formed between two electrodes positioned on a substrate.

The organic electroluminescent device may be classified into a top emission type and a bottom emission type depending on its light emission direction. Furthermore, the organic electroluminescent device may be classified into a passive matrix type and an active matrix type depending on its driving method.

Since such an organic electroluminescent device is weak to moisture or oxygen, a sealing substrate is provided in order to protect the device, and a sealing process for sealing a substrate and the sealing substrate using a sealing member, such as sealant, is performed. In the sealing process, the sealant is typically hardened by UV irradiation, thereby hermetically sealing the substrate and the sealing substrate.

In a sealing region where the sealant is disposed and UV is irradiated, a plurality of wiring lines formed on the substrate is wired. Some of these wires inhibits the sealant from being uniformly applied onto the substrate, or inhibits UV from being effectively irradiated onto the sealant, thus leading to adverse effects in the manufacture of a device.

Moreover, this problem occurs even when a sealing member other than the sealant is selected for sealing. Thus, this problem applies not only to the sealant, but also to a process for sealing using a sealing member, and improvement is required for the entire region where the sealing member is formed.

### SUMMARY

The present invention provides an organic electroluminescent device, comprising: a substrate; a display unit located on the substrate and including a plurality of subpixels; a sealing region located at the outer periphery of the display unit and defined to form a sealing member; and a plurality of wiring lines connected to the display unit and disposed on the lateral side of the display unit, more than a part of the plurality of wiring lines located in a sealing member forming region, among the plurality of wiring lines, has a narrow line width which is 10 to 50% of that of the wiring lines located in other regions.

The width of the wiring lines having a narrow line width may be 10 to 50 μm.

The wiring lines having a narrow line width may be power lines.

The power lines may become gradually narrower starting from a region spaced apart by 200 to 300 μm from the boundary line of the sealing member forming region.

The power lines may become gradually narrower with a slope of 110 to 175° toward the inside of the wiring lines.

The power lines may become gradually narrower with a slope of 150 to 175° toward the inside of the wiring lines.

### BRIEF DESCRIPTION OF THE DRAWINGS

The accompanying drawings, which are included to provide a further understanding of the invention and are incorporated on and constitute a part of this specification illustrate embodiments of the invention and together with the description serve to explain the principles of the invention.

FIG. 1 is a schematic plane view of an organic electroluminescent device according to one embodiment of the present invention;

FIG. 2 is a cross sectional view of a subpixel included in a display unit of FIG. 1;

FIG. 3 is an enlarged view of a “Z” region of FIG. 1;

FIG. 4 is a structural view of a second power line.

### DETAILED DESCRIPTION

Reference will now be made in detail embodiments of the invention examples of which are illustrated in the accompanying drawings.

Hereinafter, a concrete embodiment according to an embodiment of the present invention will be described with reference to the attached drawings.

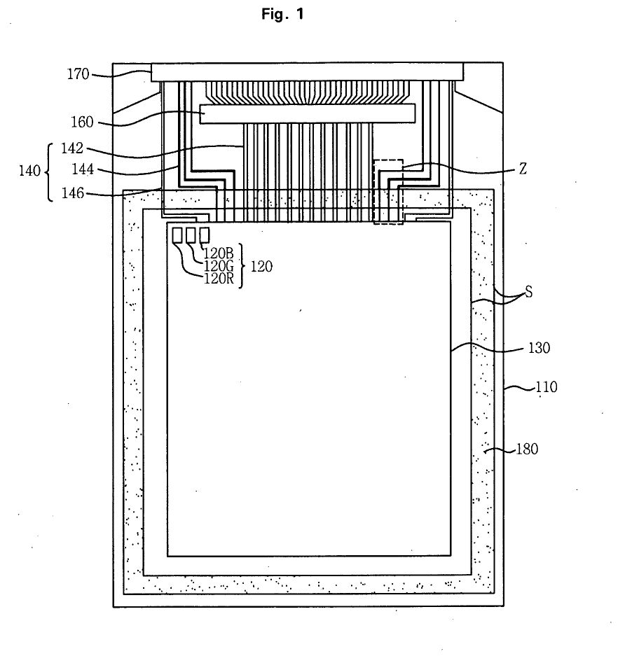

As shown in FIG. 1, an organic electroluminescent device according to one embodiment of the present invention has a display unit 130 including a plurality of subpixels 120 located on a substrate 110.

In the subpixels 120 included in the display unit 130, an organic light emitting layer is located between the anode and cathode connected to the source or drain of a driving transistor included in a transistor array located on the substrate 110. For reference, the aforementioned transistor array comprises one or more transistors and capacitors in regions corresponding to the subpixels 120.

The subpixels included in the display unit 130 comprise three subpixels 120R, 120G, and 120B emitting red, green, and blue light, and these subpixels may be defined as one pixel unit.

In the illustrated drawings, the subpixels 120 comprises only red, green, and blue, this is only one example of the embodiment and the subpixel 120 may be comprised of four or more by further including an emission color, such as white. Besides, another color (e.g., orange, yellow, etc.) may be emitted.

For reference, the subpixel 120 includes at least an organic light emitting layer, at least an emission layer, and may further include a hole injection layer, a hole transport layer, an electron transport layer, and an electron injection layer. Besides, a buffer layer, a blocking layer, and so on may be further included to adjust the flow of holes or electrons between the anode and cathode.

A sealing member forming region S forming the sealing member 180 is located on the substrate 110 at the outer periphery of the display unit 130 so that a sealing process can be performed so as to protect the device from the outside. Here, the sealing member forming region S is a virtual space defined so as to form the sealing member 180, and, as illustrated in the drawing, is also a position where the sealing member 180 is actually formed.

Meanwhile, a plurality of wiring lines 140 connected to the subpixels 120 are wired on the substrate 110 at the lateral side of the display unit 130. Especially, it is advantageous that more than a part of the plurality of wiring lines 140 has a narrow line width in the sealing member forming region which is 10 to 50% of the wiring lines positioned in other regions wired.

Here, the plurality of wiring lines 140 comprise first power lines (e.g., VDD) 146 for supplying positive power to the subpixels 120, second power lines (e.g., GND) 144 for supplying low power less than a positive power, data lines 142 for supplying data signals to the subpixels 120, and scan lines (not shown) for supplying scan signals.

Meanwhile, a driving unit 160 is located on the substrate 110 at the lateral side of the display unit 130, and a pad unit 170 is located at the outer periphery of the substrate 110 of the region adjacent to the driving unit 160. Here, the pad unit 170 is used for the purpose of connection with an external device, and the driving unit 160 serves to drive a signal supplied from the pad unit 170 and supply it to the subpixels 120 located within the display unit 130.

Among the above-described plurality of wiring lines 140, the scan lines (not shown) and the data lines 142 are connected to the driving unit 160 to transmit a signal supplied from an external device to the display unit 130.

For reference, the driving unit 160 may be divided into a scan driving unit for supplying scan signals to the respective subpixels 120R, 120G, and 120B included in the display unit 130 and a data driving unit for supplying data signals to the scanned subpixels 120R, 120G, and 120B. Although the positions of the scan driving unit and data driving unit are not illustrated in detail, the scan driving unit may be positioned at the left or right side of the lateral surface of the display unit the data driving unit may be positioned at the upper or lower side of the lateral surface of the display unit 130.

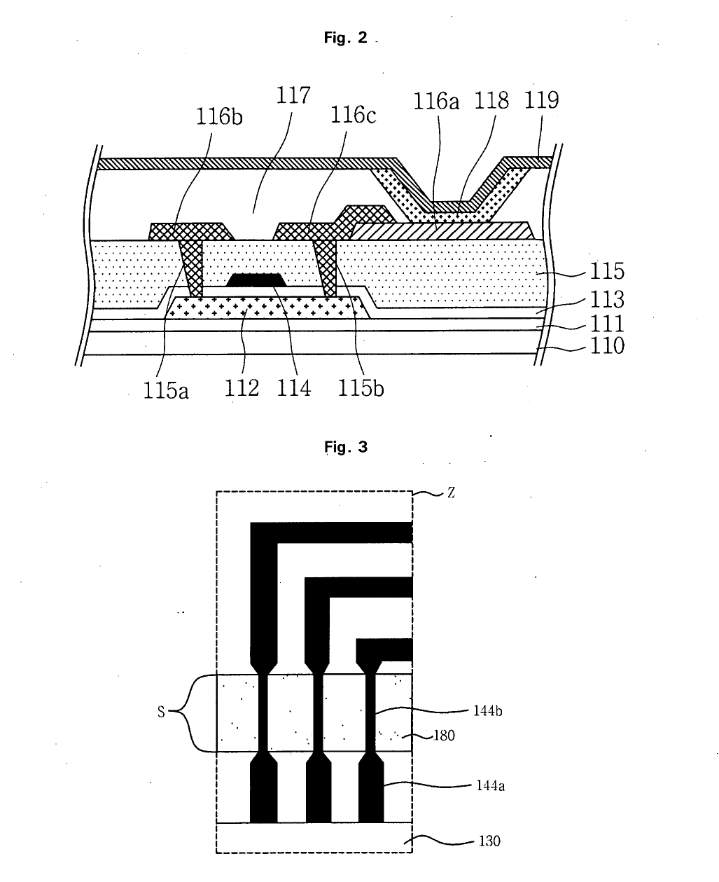

The present invention will be described by way of an example in which the organic electroluminescent device is an active matrix type. The description of the structure of the subpixels included in the display unit 130 of FIG. 1 will be described in more detail with reference to FIG. 2.

Referring to FIG. 2, a glass substrate, a metal substrate, a ceramic substrate, or a plastic substrate (polycarbonate resin, acryl resin, vinyl chloride resin, polyethyleneterephthalate resin, polyamide resin, polyester resin, epoxy resin, silicone resin, fluorine resin, etc.) can be used as the first substrate 110.

A buffer layer 111 is located on the first substrate 110. The buffer layer 111 is formed to protect a thin film transistor formed in a following process from impurities, such as alkali ions leaked from the first substrate 3110, and is selectively formed of silicon oxide (SiO2), silicon nitride (SiNx) and so on.

A semiconductor layer 112 is located on the buffer layer 111. The semiconductor layer 112 may comprise an amorphous silicon layer or a polycrystalline silicon layer which is formed by crystallizing the amorphous silicon layer. Though not shown, the semiconductor layer 112 may comprise a channel region, a source region, and a drain region, and the source region and the drain region may be doped with P-type or N-type impurities.

A gate insulation film 113 is located on the first substrate 110 including the semiconductor layer 112. The gate insulating layer 113 may be selectively formed of a silicon oxide layer SiO2 or a silicon nitride layer SiNx.

A gate electrode 114 is located on the gate insulating layer 113 so as to correspond to a predetermined region of the semiconductor layer, i.e. a channel region. The gate electrode 114 may be formed of at least one material selected from the group consisting of aluminum (Al), an Al alloy, titanium (Ti), molybdenum (Mo), a Mo alloy, tungsten (W), and tungsten silicide (WSi2).

An interlayer insulating layer 115 is located on the first substrate 110 including the gate electrode 340. The interlayer insulating layer 115 may be an organic layer, an inorganic layer, or a combination thereof. If the interlayer insulating layer 115 is an inorganic layer, it may include silicon oxide SiO2, silicon nitride SiNx, or SOG (silicate on glass). If the interlayer insulating layer 115 is an organic layer, it may include acryl resin, polyimide resin, or benzocyclobutene (BCB) resin.

First and second contact holes 125a and 125b for exposing parts of the semiconductor layer 112 may be located within the interlayer insulating layer 115 and the gate insulating layer 113.

A first electrode 116a is located on the interlayer insulating layer 115. The first electrode 116a may be an anode, and may comprise a transparent conductive layer, such as Indium Tin Oxide (ITO) or Indium Zinc Oxide (IZO). The first electrode 116a may have a lamination structure, such as ITO/Ag/TIO.

A source electrode 116b and a drain electrode 116c are located on the interlayer insulating layer 115. The source and drain electrodes 116b and 116c are electrically connected to the semiconductor layer 112 via the first and second contact holes 115a and 115b, and a part of the drain electrode 116 is located on the first electrode 116a, and electrically connected to the first electrode 116a.

The source and drain electrodes 116b and 116c may comprise a low resistance material in order to reduce wiring resistance, and may be a multi-layer film formed of moly-tungsten (MoW), titanium (Ti), aluminum (Al), or aluminum alloy (Al alloy). As the multi-layer film, a lamination structure of Ti/Al/Ti or MoW/Al/MoW can be used.

A bank layer 117 for exposing a part of the first electrode 116a is located on the first electrode 116a. The bank layer 117 may comprise an organic material, such as benzocyclobutene (BBC) resin, acryl resin, or polyiide resin.

A light emitting layer 118 is located on the exposed first electrode 116a, and a second electrode 119 is located on the light emitting layer 118. The second electrode 119 may be a cathode for supplying electrons to the light emitting layer 118, and may comprise magnesium (Mg), silver (Ag), calcium (Ca), aluminum (Al), or an alloy thereof.

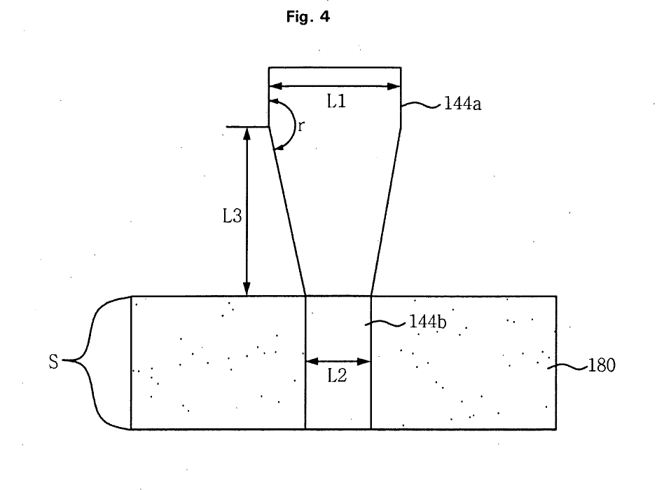

Again, referring to FIG. 1, among the above-explained plurality of wiring lines 140, the wiring lines having a narrow line width in the sealing member forming region S are used as the second power lines 144. Hereinafter, a description thereof will be made in further details with reference to FIGS. 3 and 4.

As shown in a “Z” region of FIG. 3, it can be seen that the second power lines 144 positioned within the sealing member forming region are wired so as to have a narrower line width than the wiring lines positioned in other regions. “180” denotes a sealing member.

Hereinafter, referring to FIG. 4, a wiring structure, in which the width of the second power line 144 positioned at the inner and outer sides with respect to the sealing member forming region S becomes gradually smaller as they are closer to the sealing member forming region S, will be described in more detail.

Referring to FIG. 4, if the width “L” of the second power line 144a positioned at the outer side of the sealing member forming region S is, for example, 100 μm, the width “L2” of the second power line 144b positioned within the sealing member forming region S is approximately 10 to 50 μm. “180” denotes a sealing member.

This is, as described above, because the width of the second power line 144b positioned within the sealing member forming region S may be 10 to 50% narrower than the width of the wiring lines positioned at the outer side.

If the width “L2” of the wiring lines is smaller than the range from 5 μm to 50 μm, the wiring resistance rises and thus power consumption also rises, and this leads to a decrease in luminosity due to signal distortion. Further, if the width “L2” of the wiring lines is larger than the range from 5 μm to 50 μm, the sealing member 180 to be formed on the sealing line S may not be hardened.

Meanwhile, the width of the second power line 144a positioned at the outer side of the sealing member forming region S becomes gradually narrower with respect to the boundary line of the sealing member forming region S. At this time, the section “L” where the second power line 144a become narrower is a region spaced apart by 200 to 300 μm.

Here, the width “L3” of the wring lines becomes gradually narrower starting from the region spaced apart by 200 to 300 μM with respect to the boundary line of the sealing member forming region S in consideration of the wiring resistance problem and signal distortion.

Here, the second power line 144 becomes gradually narrower with a slope of 110 to 175° toward the inside of the wiring lines. At this time, the angle r at which the second power line 144 is sloped is proportional to the wiring widths of “L1” and “L2”, the angle r may have a range of 150° to 175° at minimum.

In one example, if the second power line 144 is formed with “L1”=100 μm, “L2”=10 μM, “L3”=200 μm, the angle r may be approximately 167°, and if the second power line 144 is formed with “L1”=100 μm, “L2”=50 μm, “L3”=300 μm, the angle r may be approximately 175°. Further, if “L1” is fixed to 100 μm, the wiring lines may become gradually narrower in a range of an angle of 167° at minimum to 175° at maximum.

As above, in the present invention, for an effective sealing process, the second power line 144 having the largest wiring width among the plurality of wiring lines 140 is formed such that the wiring width is narrowed when passing through the sealing member forming region S.

Once the line width of the second power line 144 passing through the sealing member forming region S is narrowed as above, the amount of UV irradiation on the sealing increases in case the sealant is selected as the sealing member 180. Accordingly, in the sealing process, the airtightness of the device is further improved, and hence the drawback of the organic electroluminescent device weak to moisture or oxygen penetrated from the outside can be relieved and the lifespan of the device can be further improved.

Therefore, as described above, the present invention can seal the device more hermetically and improve the lifespan of the device by differentiating the wiring structure of the organic electroluminescent device.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such as limitation is not intended to be interpreted under 35 USC 112 (6).

What is claimed is:

1. An organic electroluminescent device, comprising:
a substrate;
a display unit located on the substrate and including a plurality of subpixels;
a sealing region located at the outer periphery of the display unit and defined to form a sealing member; and
a plurality of wiring lines connected to the display unit and disposed on the lateral side of the display unit,
more than a part of the plurality of wiring lines located in a sealing member forming region, among the plurality of wiring lines, has a narrow line width which is 10 to 50% of that of the wiring lines located in other regions.

2. The organic electroluminescent device of claim 1, wherein the width of the wiring lines having a narrow line width is 10 to 50 μm.

3. The organic electroluminescent device of claim 1, wherein the wiring lines having a narrow line width are power lines.

4. The organic electroluminescent device of claim 3, wherein the power lines become gradually narrower starting from a region spaced apart by 200 to 300 μm from the boundary line of the sealing member forming region.

5. The organic electroluminescent device of claim 3, wherein the power lines become gradually narrower with a slope of 110 to 175° toward the inside of the wiring lines.

6. The organic electroluminescent device of claim 3, wherein the power lines become gradually narrower with a slope of 150 to 175° toward the inside of the wiring lines.

7. The organic electroluminescent device of claim 1, wherein the subpixels comprises one or more capacitors and transistors.
